(19) United States
(12) Patent Application Publication
(10) Pub. No.: US 2026/0233480 A1
(43) Pub. Date: Aug. 13, 2026

(54) METHOD FOR PRODUCING A PNEUMATIC TYRE

(71) Applicant: Continental Reifen Deutschland GmbH, Hannover (DE)

(72) Inventors: Rainer Mauruschat, Garbsen (DE); Stephan Knull, Hannover (DE)

(73) Assignee: Continental Reifen Deutschland GmbH, Hannover (DE)

(21) Appl. No.: 19/154,700

(22) PCT Filed: Jan. 17, 2024
(86) PCT No.: PCT/DE2024/035004

§ 371 Date: Aug. 7, 2025

(30) Foreign Application Priority Data
Feb. 17, 2023 (DE) 10 2023 201 388.6

(51) Int. Cl. B29D 30/32; B29D 30/36

(52) U.S. Cl. CPC B29D 30/32; B29D 30/36; B29D 2030/3207; B29D 2030/3214; B29D 2030/3221

(57) ABSTRACT

A method, device, system and a computer product for producing a pneumatic tire are disclosed. The method comprising placing the inner layer and the carcass ply on a tire building drum and on a supporting ring with a bladder, moving core fixings radially to a larger radius, where the radius to which the core fixings are moved is greater than the unexpanded radius of the tire building drum, moving the core fixings radially to a smaller radius, forming tire shoulders by expanding the tire building drum, setting a bead core on the carcass ply at the drum shoulder, fixing the bead core by the radially movable core fixing, turning up the carcass ply and the inner layer by a bladder.

### CROSS-REFERENCE TO RELATED APPLICATIONS

This application is a National Stage Application under 35 U.S.C. § 371 of International Patent Application No. PCT/DE2024/035004 filed on Jan. 17, 2024 and claims priority from German Patent Application No. 10 2023 201 388.6 filed on Feb. 17, 2023, the disclosures of which are herein incorporated by reference in their entireties.

### BRIEF SUMMARY

A method for producing a pneumatic tire with an inner layer, a carcass ply, a bead core, a tire belt and a tread strip. The invention also relates to a device for producing a pneumatic tire with an expandable tire building drum and dimensionally stable core fixings arranged axially in relation to the tire building drum and to a computer program product.

In the two-stage tire production method, after an inner layer and a carcass ply have been wrapped around during the process of building up a pneumatic tire, a shoulder is formed, for example by the expansion of the carcass drum. Before the plies are turned up, a bead core is put in place.

For the uniformity of a tire, it is relevant that, seen over the circumference, the inner layer and the carcass ply have small differences in length as well as uniform mechanical tension between the bead cores. The requirements for tire uniformity are becoming greater, while, with the same processes, the differences in the length of the inner layer and the carcass ply between the bead cores are increasing due to carcass plies with higher rigidity. Therefore, when the tire has to meet a high uniformity requirement, known methods and devices produce increased wastage or are particularly complex, especially when using carcass plies with high rigidities, which increases the cycle time and reduces the cost-effectiveness of the method.

Against this background, the invention is based on the object of implementing a method and a device as well as a computer program product in such a way that reliably made pneumatic tires with an inner layer and a carcass ply which, when seen over the circumference, have particularly small differences in length between the bead cores can be produced without any increase in the cycle time, or at least with only a small increase in the cycle time, in order to reliably meet high uniformity requirements for pneumatic tires.

This object is achieved by a method according to the features of patent claim 1 and by a device and a computer program according to the additional independent claims. The dependent claims relate to particularly advantageous developments of the invention.

A method for producing a pneumatic tire with an inner layer, a carcass ply, a bead core, a tire belt and a tread strip is provided, comprising the following steps:
a) placing the inner layer and the carcass ply on a tire building drum and on a supporting ring with a bladder,
b) moving core fixings radially to a larger radius, where the radius to which the core fixings are moved is greater than the unexpanded radius of the tire building drum,
c) moving the core fixings radially to a smaller radius, where the radius to which the core fixing is moved is not greater than the unexpanded radius of the tire building drum,
d) forming tire shoulders by expanding the tire building drum,
e) setting a bead core on the carcass ply at the drum shoulder,
f) fixing the bead core by the radially movable core fixing,
g) turning up the carcass ply and the inner layer around the bead core by filling a bladder,
h) finishing the green tire by further steps.

By moving the core fixings radially to a radius which is greater than the unexpanded radius of the tire building drum, the inner layer and the carcass ply are moved to a larger radius over the circumference in the area of the core fixings. The inner layer and the carcass are thereby detached from the bladders to which they previously adhered, in particular by applying rollers. When the tire building drum is subsequently expanded, the areas of the inner layer and carcass that are not lying in contact, as well as the reduced adhesive attachment of the inner layer and the carcass to the bladders in areas where the inner layer is lying on the bladders, result in smaller differences in the length of the inner layer and the carcass ply between the bead cores. Furthermore, a particularly uniform tension is achieved in the inner layer and the carcass ply between the bead cores.

An embodiment provides that, immediately after step a), the carcass ply is rolled against the inner layer. Rolling of the carcass ply against the inner layer improves the adhesive bond between the carcass ply and the inner layer, whereby a reduced relative movement between these layers is achieved and thus a particularly uniform pneumatic tire can be produced.

Another embodiment provides that, after step d), rollers are moved to a smaller radius, for applying the inner layer and the carcass ply to the drum shoulder. The moving of the rollers and the application of the inner layer and the carcass ply lead to a further equalization of the length of the inner layer and the carcass ply between the bead cores.

Another embodiment provides that, in step b), the core fixings are moved to a radius for producing areas of the inner layer that are not lying on the bladder, where the radius is chosen such that the area of the inner layer that is not lying on the bladder is of an extent in the axial direction of the tire building drum which is not greater than the area of the inner layer forming the tire shoulder. By forming an area of the inner layer that is not lying on the bladders which is smaller than the area required for forming the tire shoulder, abnormalities and irregularities of the inner layer of the formed tire shoulder are avoided.

Another embodiment provides that step c) and d) are performed simultaneously. Performing steps c) and d) simultaneously reduces the process time. Furthermore, the time that the inner layer is in contact with the bladders after the relative movement has been carried out and before the tire shoulder is formed, which can lead to an increase in adhesive attachment, is kept down.

A device for producing a pneumatic tire with an expandable tire building drum and dimensionally stable core fixings arranged axially in relation to the tire building drum is provided, the device being designed to perform the method according to the invention.

Such a device allows the method according to the invention to be carried out and thus allows the production of pneumatic tires with an inner layer and a carcass ply which have over the circumference particularly small differences in length between the bead cores.

The invention provides a computer program product for operating a device for producing a pneumatic tire, comprising instructions which, when the program is executed by at least one processor unit, cause it to perform the method according to the invention.

### BRIEF DESCRIPTION OF THE SEVERAL VIEWS OF THE DRAWINGS

The invention permits numerous embodiments. To further illustrate its basic principle, one of these is shown in the drawings and will be described in the following text. In the drawing:

FIG. 1 shows an expandable tire building drum with an inner layer and a carcass ply;

FIG. 2 shows the expandable tire building drum during the moving of the core fixings;

FIG. 3 shows the tire building drum in the expanded state.

### DETAILED DESCRIPTION

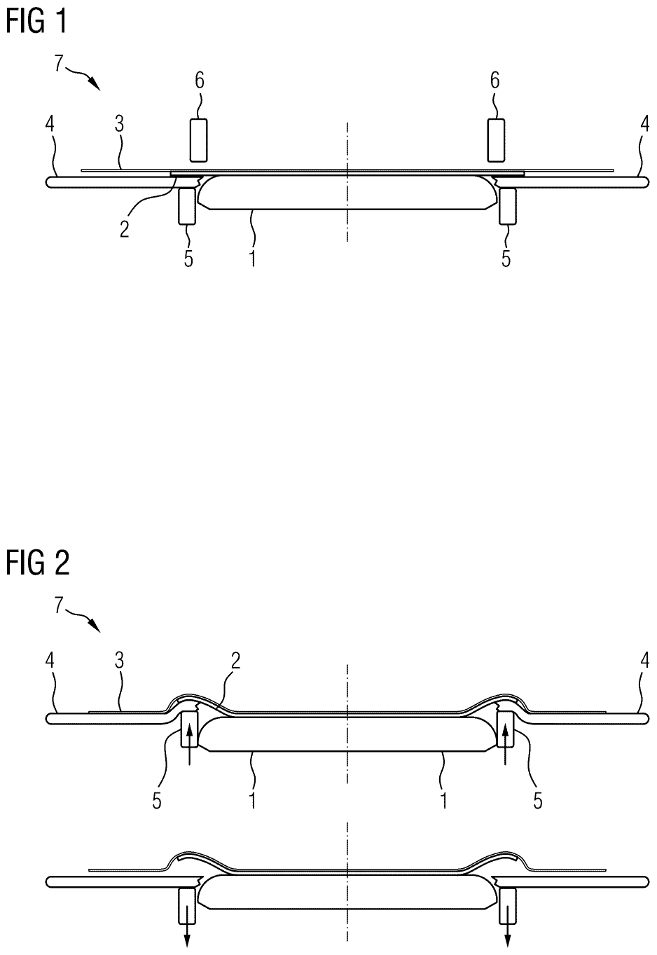

FIG. 1 shows an expandable tire building drum 1 on which an inner layer 2 and a carcass ply 3 of a pneumatic tire have already been placed. The tire building drum 1 is in an unexpanded state. In the axial direction of the tire building drum 1, bladders 4 and core fixings 5 are arranged to the right and left of the tire building drum 1. The core fixings 5 are arranged in the radial direction of the tire building drum 1 such that the bladders 4 are located on a radius which is smaller than the radius of the surface of the tire building drum 1. Rollers 6 roll the carcass ply 3 against the inner layer 2.

An expansion of the tire building drum 1 can lead to a variance on the circumference with respect to the mechanical tension in the inner layer 2 and the carcass ply 3 due to the adhesive attachment of the inner layer 2 and the carcass ply 3 to a bladder 4.

To reduce this variance, as shown at the top of FIG. 2, the core fixings 5, of the device 7 known from FIG. 1, move radially outward, so that the bladder 4 and the inner layer 2 lying on it, as well as the carcass ply 3, are moved radially outward on the circumference of the core fixing 5. This causes the axially outer ends of the inner layer 2 and the carcass ply 3 to be moved toward each other; adhesive attachment is overcome. Subsequently, as shown at the bottom of FIG. 2, the core fixings 5 are retracted to their starting position, the bladders 4 following the core fixings 5. The inner layer 2 and the carcass ply 3 remain in their position due to their rigidity and their adhesive bond to each other as well as to the bladders 4; they do not follow the core fixings 5.

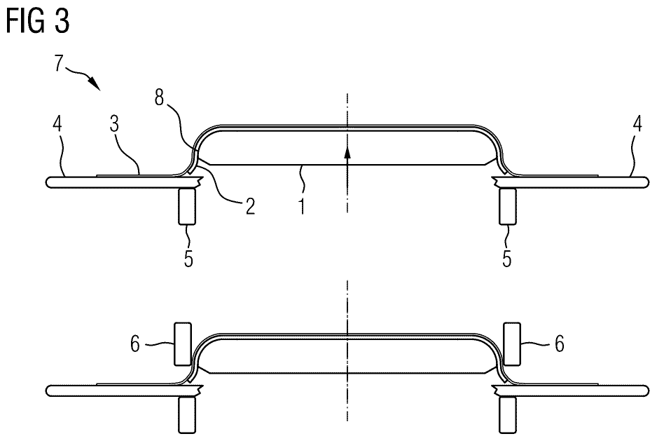

In FIG. 3, the device 7 known from FIG. 1 is shown with the tire building drum 1 in the expanded state. The inner layer 2 and the carcass ply 3 lie against the drum shoulders 8 geometrically uniformly and with uniform tension, since they were already detached from the bladders 4 before the expansion of the tire building drum 1. As shown at the bottom of FIG. 3, after the expansion of the tire building drum 1, the rollers 6 move along the drum shoulders 8 to the bladders 4 and increase the uniformity with which the inner layer 2 and the carcass ply 3 lie against the drum shoulders 8.

Bead cores are subsequently put in place on the carcass ply 3. The bead cores are fixed with the core fixings 5 before the bladders 4 are filled for turning up the carcass.

### List of Reference Signs

1 Tire building drum
2 Inner layer
3 Carcass ply
4 Bladder
5 Core fixing
6 Rollers
7 Device
8 Drum shoulder

1. A method for producing a pneumatic tire with an inner layer, a carcass ply, a bead core, a tire belt and a tread strip, the method comprising:
a) placing the inner layer and the carcass ply on a tire building drum and on a supporting ring with a bladder,
b) moving core fixings radially to a larger radius, where the radius to which the core fixings are moved is greater than the unexpanded radius of the tire building drum,
c) moving the core fixings radially to a smaller radius, where the radius to which the core fixing is moved is not greater than the unexpanded radius of the tire building drum,
d) forming tire shoulders by expanding the tire building drum,
e) setting a bead core on the carcass ply at the drum shoulder,
f) fixing the bead core by the radially movable core fixing,
g) turning up the carcass ply and the inner layer around the bead core by filling a bladder, and
h) finishing the green tire.

2. The method as claimed in claim 1, wherein, immediately after step a), the carcass ply is rolled against the inner layer.

3. The method as claimed claim 1, wherein, after step d), rollers are moved to a smaller radius, for applying the inner layer and the carcass ply to the drum shoulder.

4. The method as claimed in claim 1, wherein, in step b), the core fixings are moved to a radius for producing areas of the inner layer that are not lying on the bladder, where the radius is chosen that the area of the inner layer that is not lying on the bladder is of an extent in the axial direction of the tire building drum which is not greater than the area of the inner layer forming the tire shoulder.

5. The method as claimed in claim 1, wherein steps c) and d) are performed simultaneously.

6. The method of claim 1, further comprising:
Providing a device for producing the pneumatic tire with an expandable tire building drum and dimensionally stable core fixings arranged axially in relation to the tire building drum.

7. The method of claim 1, further comprising instructions which, when the program is executed by at least one processor unit, cause it to perform the method.

8. A tire building system comprising:
a tire building drum on a supporting ring with a bladder;
a processor having instructions executed to:
place an inner layer and a carcass ply on the tire building drum and on the supporting ring with a bladder;
move core fixings radially to a larger radius;
move the core fixings to a smaller radius;
expand the tire building drum to form tire shoulders;
set a bead core on the carcass ply at the drum shoulder;
fix the bead core by the radially movable core fixing; and
turn up the carcass ply and the inner layer around the bead core by filling the bladder.

9. The system of claim 8, the processor further having instructions to roll the carcass ply against the inner layer.

10. The system of claim 8, the processor further having instructions to cause the axially outer ends of the inner layer and of the carcass ply to move toward each other by the bladder.

11. The system of claim 8, the processor further having instructions to cause the inner layer and the carcass ply to lie against the drum shoulders geometrically uniformly and with uniform tension.

12. The system of claim 8, the processor further having instructions to fix bead cores with the core fixings to place the bead cores in place on the carcass ply.

13. A tire building system comprising:
a building drum having an unexpanded state;
bladders arranged to a first side of the building drum;
core fixings arranged to a second side of the building drum and arranged in a radial direction of the building drum;
wherein the bladders are located on a radius smaller than a radius of the building drum;
wherein the core fixings are configured to move radially outward to cause the bladder and an inner layer to move radially outward and cause axially outer ends of the inner layer and axially outer ends of a carcass ply to move toward each other.

14. The system of claim 13, wherein the core fixings are further configured to retract towards a starting position while the inner layer and the carcass ply remain in their position based at least partly on an adhesive bond.
